(19) United States
(12) Patent Application Publication
(10) Pub. No.: US 2007/0163398 A1
(43) Pub. Date: Jul. 19, 2007

(54) Structure of wrench changeable in active turning direction

(76) Inventor: Yu-Lan Lai Lee, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/332,359

(22) Filed: Jan. 17, 2006

(51) Int. Cl. B25B 13/46; B25B 13/00

(52) U.S. Cl. 81/59.1; 192/44; 192/45

(57) ABSTRACT

A wrench includes a main body, an engaging member, a direction setting plate, beads, several twin holes on the setting plate, and rolling elements; the engaging member has spaced external protruding portions, and concavities between every two adjacent protruding portions; the setting plate has spaced protrusions equidistant from the center; the beads are fitted on and biased away from the engaging member and pressed against the setting plate, and each fitted on one of corresponding twin holes; the rolling elements are respectively positioned in the spaces between every two adjacent protrusions; the main body will cause the engaging member to turn when each bead is fitted on a first one of corresponding twin holes, and when it is turned in an active direction; the main body won't cause the engaging member to turn together with it when it is turned in an inactive direction opposite to the active one.

### BACKGROUND OF THE INVENTION

1. Field of the Invention

The present invention relates to a wrench changeable in active turning direction, more particularly one, which has several rolling elements for effecting engagement between an engaging member and a main body thereof, thus eliminating the situation wherein ratchets are used on ratchet wrenches and prone to wear and collapse over time.

2. Brief Description of the Prior Art

Many kinds of tools are available for driving screws and nuts, e.g. adjustable spanners, flare nut spanners, open end spanners, and ratchet wrenches. Ratchet wrenches can be changed in active turning direction, and are relatively convenient to use.

Referring to FIG. 8, a currently existing ratchet wrench includes a handle 91, a ratchet 92, a rotation effecting member 93, and an active turning direction setting element 94. The handle 91 has a holding space 911 at one end. The ratchet 92 has ratchet teeth 921 on an outer side, and it is held in the holding space 911 of the handle 91. The rotation effecting member 93 is fitted to the handle 91 for engaging the ratchet teeth 921 of the ratchet 92 while the active turning direction setting element 94 is fitted to the handle 91 for choosing an active turning direction of the handle 91, in which direction the rotation effecting member 93 will cause the ratchet 92 to turn with the handle 91. Therefore, after the ratchet 92 is fitted around a rotatively driven element such as a screw and a nut, the rotatively driven element will be turned only when the handle 91 is turned in the active turning direction.

However, the ratchet teeth of the ratchet will wear and become incapable of effectively engaging over time. Furthermore, the ratchet teeth are prone to collapse, and the wrench will become useless if the wrench is subjected to excessive torque.

### SUMMARY OF THE INVENTION

It is a main object of the invention to provide an improvement on a wrench changeable in an active direction to overcome the above problems.

The wrench of the present invention includes a main body, an engaging member, a direction setting plate, beads, several twin locating holes on the setting plate, and rolling elements. The engaging member has spaced external protruding portions, and concave portions between every two adjacent protruding portions. The direction setting plate has spaced protrusions, which are equidistant from the center. The beads are fitted on and biased away from the engaging member and pressed against the direction setting plate; each of the beads is fitted on a chosen one of corresponding twin holes. The rolling elements are respectively positioned in the spaces between every two adjacent protrusions of the setting plate; thus, the main body will engage the engaging member and the direction setting plate to cause the engaging member to turn when each of the biased beads is fitted on a first one of corresponding twin holes, and when the main body is turned in a first (active) direction; the wrench main body will turn relative to the engaging member when each of the beads is fitted on the first one of corresponding twin locating holes, and when the wrench main body is turned in a second (inactive) direction opposite to the first one. Further, the wrench main body will cause the engaging member to turn together with it when each of the beads is fitted on a second one of corresponding twin locating holes, and when the wrench main body is turned in the second direction; the active turning direction can be set by means of turning the setting plate to relocate the beads.

### BRIEF DESCRIPTION OF THE DRAWINGS

The present invention will be better understood by referring to the accompanying drawings, wherein:

FIG. 1 is an exploded perspective view of the present invention,

FIG. 2 is a sectional view of the present invention,

FIG. 3 is a view of the present invention with the beads being fitted on locating holes at position A,

FIG. 4 is a view of the present invention in use, with the beads being fitted on locating holes at position A,

FIG. 5 is a view of the present invention with the wrench main body being turned in an inactive direction,

FIG. 6 is a view of the present invention with the beads being fitted on locating holes at position B,

FIG. 7 is a view of the present invention in use, with the beads being fitted on locating holes at position B, and

FIG. 8 is an exploded perspective view of the prior art.

### DETAILED DESCRIPTION OF THE PREFERRED EMBODIMENTS

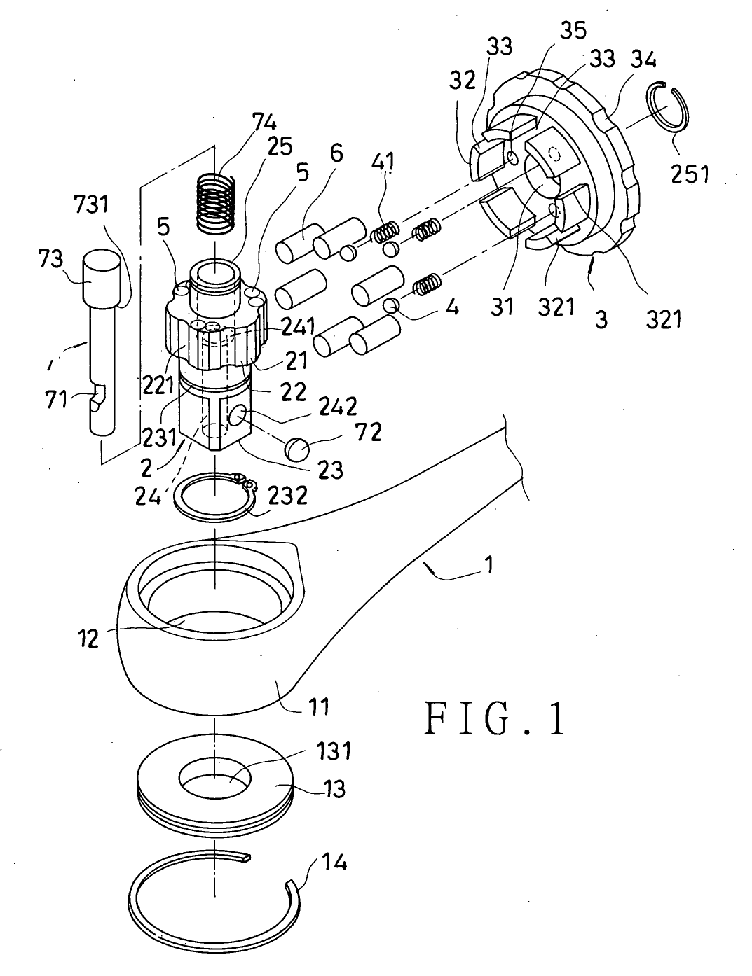

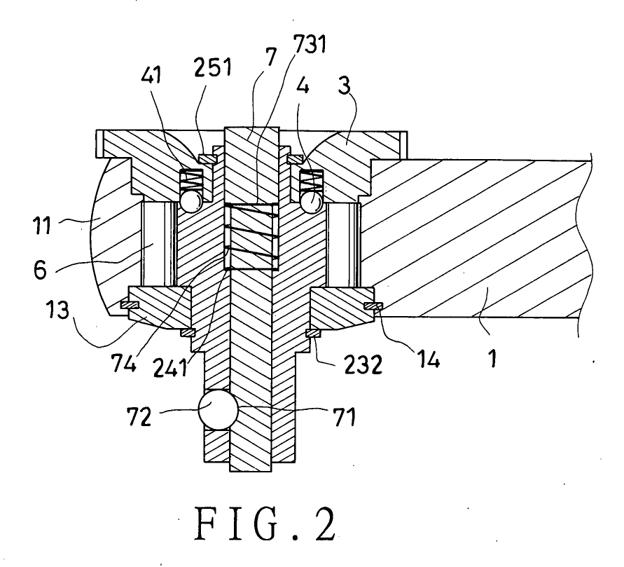

Referring to FIGS. 1 to 7, a preferred embodiment of a wrench changeable in active turning direction in the present invention includes:

a wrench main body 1; the wrench main body 1 includes a head 11 at one end, and a covering part 13; the head 11 has a holding space 12 encompassed by an inner side therein; the covering part 13 has a hole 131 on a middle, and it is positioned on one side of the head 11 to cover the holding space 12; further, the covering part 13 is secured to the head 11 by means of a fastening ring 14;

an engaging member 2; the engaging member 2 has several protruding portions 21 spaced apart on an outer side of a first end, a fitting portion 25 projecting from the first end, and several concave portions 22 spaced apart on the outer side of the first end and between every two adjacent ones of the protruding portions 21; further, each of the concave portions 22 has an inwardly curved portion 221 thereon; the engaging member 2 has a square part 23 at the other end, which has a holding room 24 therein; the holding room 24 has a step-shaped portion 241; the square part 23 has a through hole 242 communicating with the holding room 24 and extending to an outer side thereof; the square part 23 is used for connection to a coupling, e.g. various sizes of hexagonal couplings, couplings for connection with driver heads, and heads of other kinds of tools, which coupling will be connected to an object such as screw and nut in order for allowing the object to be turned together with the square part 23; the square part 23 has a trench 231 on an outer side, and a fastening ring 232; the square part 23 is passed through the hole 131 of the covering part 31, and the fastening ring 232 is fitted in the trench 231 and pressed against the covering part 13; further, the engaging member 2 has several twin locating holes 5 (at positions A and B respectively) thereon, and the distance between a same pair of locating holes 5 is relatively small and smaller than that between different pairs of locating holes 5;

a direction setting plate 3; the direction setting plate 3 has a through hole 31 on a middle, several upright protruding portions 32 spaced apart on one side, equidistant from the center of the direction setting plate 3, and spaces 33 between every two adjacent ones of the upright protruding portions 32; each of the upright protruding portions 32 has two sloping lateral sides 321; the engaging member 2 is passed through the through hole 31 of the direction setting plate 3 at the fitting portion 25, and a fastening ring 251 is secured around a portion of the fitting portion 25 that is outside the through hole 31 such that the engaging member 2 is prevented from being linearly displaced relative to the covering part 13 and the direction setting plate 3 by means of the fastening rings 232 and 251; further, the direction setting plate 3 has several slip-prevention gaps 34 on an edge therefore when the direction setting plate 3 is turned, there won't be slipping; further, the direction setting plate 3 has several holding holes 35 on an inner side thereof;

several beads 4 each biased with an elastic element 41; the elastic elements 41 are positioned in respective ones of the holding holes 35 of the direction setting plate 3, and the beads 4 are positioned on tail ends of the respective elastic elements 41 such that they are biased and pressed against the engaging member 2 by means of the elastic elements 41, and each faces one pair of the locating holes 5 of the engaging members 2;

several rolling elements 6 each positioned in one of the spaces 33 of the direction setting plate 3, which form between every two adjacent ones of the upright protruding portions 32; in the preferred embodiment, the rolling elements 6 are cylindrical;

a central shaft 7 passed through the holding room 24 in the square part 23 of the engaging member 2; the central shaft 7 has a bead holding gap 71 on one side, and a stopping bead 72 is fitted in the bead holding gap 71; the central shaft 7 has a head 73 at one end, and a step-shaped portion 731 forms owing to the existence of the central shaft 7; the central shaft is passed through an elastic element 74 and the holding room 24 with the elastic element 74 being pressed against the step-shaped portions 731 and 241 at two ends thereof; the stopping bead 72 is fitted in the bead holding gap 71, and passes through the through hole 242 of the square part 23 to partly protrude outside.

Or alternatively, the engaging member 2 can be formed with holding holes 35 for holding the elastic elements 41, and the direction setting plate 3 can be formed with locating holes 5 for the beads 4 to fit onto.

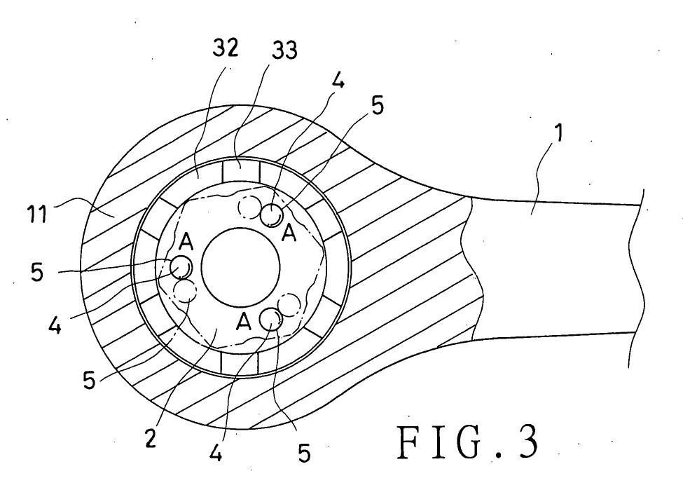

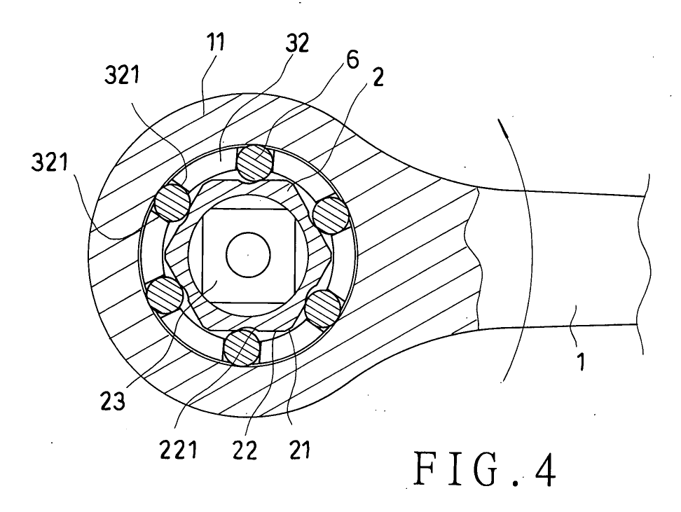

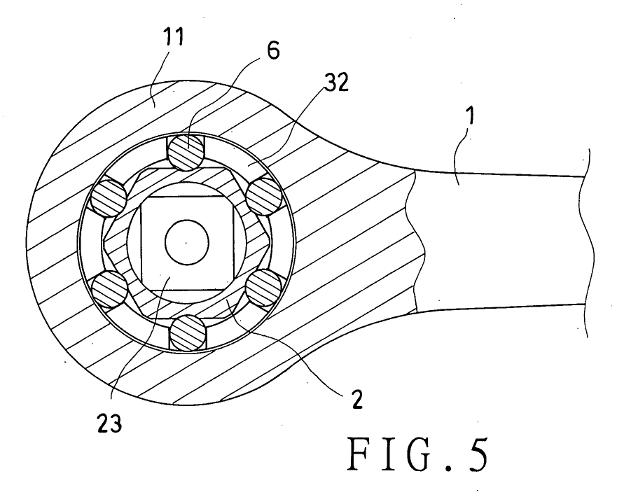

Referring to FIG. 3, when the direction setting plate 3 is turned so as to make the beads 4 fitted in respective ones of the holding holes 5 at position A, the rolling elements 6 will be near to first sides of the protruding portions 21 of the engaging member 2; therefore, if the wrench main body 1 is turned in a first direction shown with the arrow in FIG. 4, the protruding portions 21 of the engaging member 2 will press the rolling elements 6, and in turn the rolling elements 6 are pressed against the upright protruding portions 32 as well as the wrench main body 1; more detailed, the first sides of the protruding portions 21 together with the inner side of the head 11 of the wrench main body 1, which encompasses the holding space 12, will make the rolling elements 6 pressed against the lateral sides 321 of the upright protruding portions 32; consequently, the wrench main body 1 will engage the engaging member 2 with the help of the rolling elements 6, and the engaging member 2 will cause an object coupled to the square part 23 to turn together with it when the wrench main body 1 is turned in the first direction shown with the arrow in FIG. 4. If the beads 4 are fitted in respective ones of the holding holes 5 at position A, and the wrench main body 1 is turned in a second direction opposite to the first one, the rolling elements 6 will move onto the concave portions 22 of the engaging member 2; more detailed, the rolling elements 6 will fall onto the inwardly curved portions 221 of the concave portions 22, as shown in FIG. 5. Consequently, when the user turns the wrench main body 1, the wrench main body 1 will turn relative to the engaging member 2, incapable of causing the engaging member 2 to turn together with it; after the wrench main body 1 is turned in the second (inactive) direction by a certain angle, the wrench main body 1 is allowed to be turned in the first (active) direction again to cause the object coupled to the square part 23 to turn.

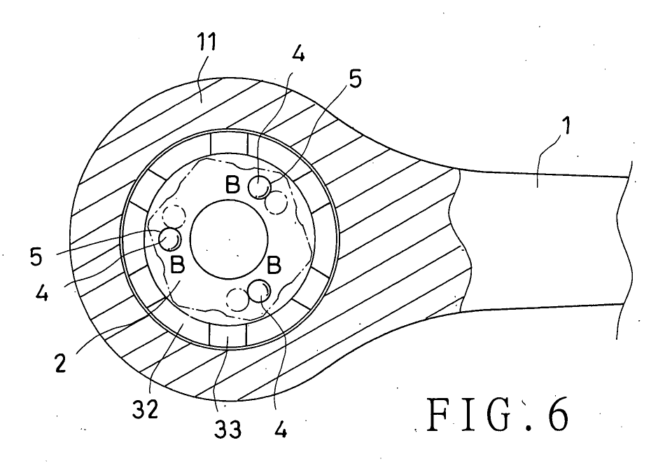

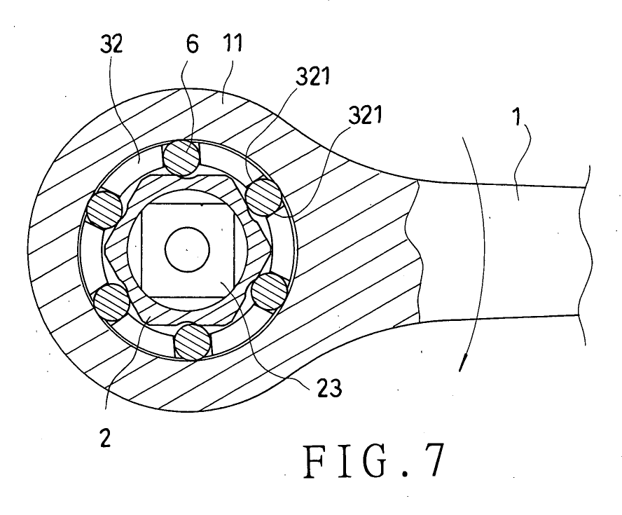

Referring to FIG. 6, when the direction setting plate 3 is turned so as to make the beads 4 fitted in respective ones of the holding holes 5 at position B, the rolling elements 6 will be near to second (the other) sides of the protruding portions 21 of the engaging member 2; if the wrench main body 1 is turned in a direction shown with the arrow in. FIG. 7, the protruding portions 21 of the engaging member 2 will press the rolling elements 6, and in turn the rolling elements 6 are pressed against the upright protruding portions 32 as well as the wrench main body 1; more detailed, the second sides of the protruding portions 21 together with the inner side of the head 11 of the wrench main body 1 will make the rolling elements 6 pressed against the lateral sides 321 of the upright protruding portions 32; consequently, the wrench main body 1 will engage the engaging member 2 with the help of the rolling elements 6, and the engaging member 2 will cause an object coupled to the square part 23 to turn together with it when the wrench main body 1 is turned in the direction shown with the arrow in FIG. 7. If the beads 4 are fitted in respective ones of the holding holes 5 at position B, and the wrench main body 1 is turned in the other direction opposite to the above-mentioned one, the rolling elements 6 will move onto the concave portions 22 of the engaging member 2, as shown in FIG. 5. Consequently, when the user turns the wrench main body 1, the wrench main body 1 will turn relative to the engaging member 2, incapable of causing the engaging member 2 to turn together with it; after the wrench main body 1 is turned a certain angle in the inactive direction, the wrench main body 1 is allowed. to be turned in the active direction again so as to cause the object coupled to the square part 23 to turn.

From the above description, it can be easily seen that the active turning direction of the wrench main body 1 can be set by means of turning the direction setting plate 3. In other words, the user is allowed to choose and use either one of the two opposite directions as the active turning direction of the wrench main body 1.

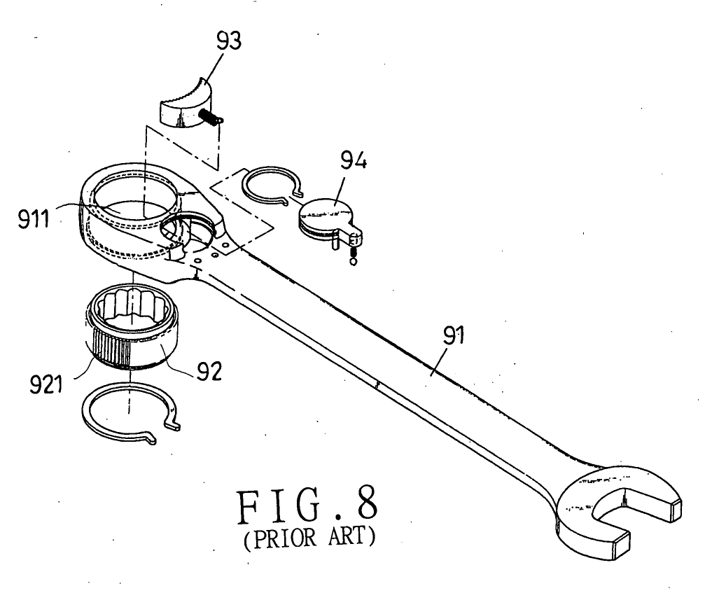

The engaging member 2 of the present invention can be equipped with a hollow engaging part (not shown in Figs.) instead of the square part 23, the central shaft 7, the beads 72, the fitting portion 25, and the fastening ring 232 of the above preferred embodiment, which hollow engaging part has an engaging hole allowing an object to fit in so that the object can be turned by means of turning the wrench main body 1. Further, the hollow engaging part is formed with teeth on an inner side thereof; thus, the hollow engaging part can be directly fitted around a nut or a screw head, like the ratchet of the prior art shown in FIG. 8.

From the above description, it can be seen that the present invention has the following advantages:

1. The present invention eliminates the situation wherein ratchets are used on wrenches and prone to wear and collapse after having been used for a length of time. Friction caused by the rolling elements of the wrench of the present invention is relatively small therefore the wrench won't wear even if it has been used for a long time.

2. The active turning direction of the wrench can be set by means of turning the direction setting plate therefore the present invention is convenient to use.

3. Conventional ratchet wrenches will produce annoying “da da da” noise when they are used. When the wrench main body of the present invention is turned in the inactive direction, the rolling elements will turn, and in turn the wrench won't produce any noise.

What is claimed is:

1. An improvement on a wrench changeable in active turning direction, comprising
a wrench main body having a head at one end; the head having a holding space therein;
an engaging member having a plurality of protruding portions spaced apart on an outer side thereof, and a plurality of concave portions spaced apart on the outer side and between every two adjacent ones of the protruding portions;
a direction setting plate; the direction setting plate having a through hole on a middle thereof; the direction setting plate having a plurality of upright protruding portions spaced apart on one side, equidistant from a center thereof; the direction setting plate having a plurality of spaces between every two adjacent ones of the upright protruding portions thereof;
a plurality of beads fitted on and biased away from one of both the engaging member and the direction setting plate and pressed against other one of both the engaging member and the direction setting plate;
a plurality of twin locating holes formed on one of both the engaging member and the direction setting plate so as to face in a direction opposite to the beads; each of the biased beads being fitted on one of corresponding twin locating holes; and
a plurality of rolling elements each positioned in one of the spaces between every two adjacent ones of the upright protruding portions of the direction setting plate;
the wrench main body being going to engage both the engaging member and the direction setting plate so as to cause the engaging member to turn together with it when each of the biased beads is fitted on a first one of corresponding twin locating holes, and when the wrench main body is turned in a first direction; the wrench main body being going to turn relative to the engaging member when each of the beads is fitted on the first one of corresponding twin locating holes, and when the wrench main body is turned in a second direction opposite to the first one;
the wrench main body being going to engage both the engaging member and the direction setting plate so as to cause the engaging member to turn together with it when each of the beads is fitted on a second one of corresponding twin locating holes, and when the wrench main body is turned in the second direction; the wrench main body being going to turn relative to the engaging member when each of the beads is fitted on the second one of corresponding twin locating holes, and when the wrench main body is turned in the first direction.

2. The wrench changeable in active turning direction as claimed in claim 1, wherein the engaging member has a square part, which has a holding room therein; the square part having a through hole communicating with the holding room and extending to an outer side; a central shaft being passed through the holding room in the square part of the engaging member; the central shaft having a bead holding gap on one side; a stopping bead being fitted in the bead holding gap of the central shaft, and passes through the through hole of the square part to protrude outside.

3. The wrench changeable in active turning direction as claimed in claim 2, wherein the central shaft has a head at one end thereof, and a step-shaped portion, which forms owing to existence of the central shaft, and the square part has a step-shaped portion in the holding room thereof; the central shaft being passed through an elastic element and the holding room of the square part with the elastic element being pressed against the step-shaped portions of both the central shaft and the holding room in the square part at two ends thereof.

4. The wrench changeable in active turning direction as claimed in claim 3, wherein the square part has a trench, and a fastening ring is fitted in the trench of the square part.

5. The wrench changeable in active turning direction as claimed in claim 1, wherein a covering part is positioned over one side of the holding space of the wrench main body; the covering part having a hole on a middle.

6. The wrench changeable in active turning direction as claimed in claim 5, wherein the covering part is secured to the wrench main body by means of a fastening ring.

7. The wrench changeable in active turning direction as claimed in claim 1, wherein the engaging member has a fitting portion, which is passed through the through hole of the direction setting plate; a fastening ring being positioned around the fitting portion.

8. The wrench changeable in active turning direction as claimed in claim 1, wherein each of the beads is positioned in a holding hole, and biased outwardly of the holding hole by an elastic element held in the holding hole.

9. The wrench changeable in active turning direction as claimed in claim 8, wherein the plural twin locating holes are formed on the engaging member instead, and the holding holes are formed on the direction setting plate.

10. The wrench changeable in active turning direction as claimed in claim 1, wherein each of the upright protruding portions of the direction setting plate has two sloping lateral sides.

11. The wrench changeable in active turning direction as claimed in claim 1, wherein the direction setting plate has a plurality of slip-prevention gaps on an edge; thus, when the direction setting plate is turned, there won't be slipping.

12. The wrench changeable in active turning direction as claimed in claim 1, wherein the engaging member has an engaging hole thereon.
